(19) United States
(12) Patent Application Publication
(10) Pub. No.: US 2003/0112453 A1
(43) Pub. Date: Jun. 19, 2003

(54) Scaling factor tools

(75) Inventor: Donald L. Swihart, Stillwater, MN (US)

Correspondence Address: Attention: Amelia A. Buharin, Imation Corp., Legal Affairs, P.O. Box 64898, St. Paul, MN, 55164-0898, US

(73) Assignee: Imation Corp.

(21) Appl. No.: 10/024,843

(22) Filed: Dec. 18, 2001

(51) Int. Cl. B41B 1/00; G06F 15/00

(52) U.S. Cl. 358/1.2; 358/1.9

(57) ABSTRACT

In general, the invention provides scaling tools for compensating for scaling variations between two printing systems, such as an analog printing system and a digital printing system. An operator designates one of the systems as the reference printing system and the other printing system as the scalable printing system. The operator constructs a reference grid with the reference printing system and a scaling grid with the scalable printing system. By comparing the reference grid and the scaling grid, the operator finds one or more scaling factors, which the operator may use to set the scale of the scalable printing system. The operator may print an image using the reference printing system and the scalable printing system, and the scalable printing system prints to the same scale as the reference printing system.

### TECHNICAL FIELD

The invention relates to printing systems, and more particularly, to color printing systems.

### BACKGROUND

In color image reproduction, the image is often color-separated into two or more halftone dot films. CMYK imaging makes use of four halftone dot films, one each for cyan, magenta, yellow and black. A color proof is prepared that combines the color-separated halftone dot films into a single print, and the proof image may be checked for accuracy of the image. In particular, the proof shows whether the halftone dots are positioned properly relative to each other, so that the final color print will provide an accurate and consistent representation of the image.

Two kinds of color printing systems, analog and digital, are in use. In an analog color printing system, the halftone dot images are stored on photosensitive media, such as films containing silver halide. A color proof is constructed by individually imaging and developing each representative color halftone dot film. The proof is constructed by laying the individual colors upon a substrate or image receptor.

In a digital color printing system, an image is stored as digitized data. The data are converted to hard copy with a printer, such as a laser thermal printer. In a typical laser thermal printer, a receptor is placed in contact with a color-coated “donor” sheet, and a plurality of laser beams are directed at the donor. Each laser emits an infrared beam, and the colored coating heats when exposed to a beam, causing colorant to transfer from the donor to the receptor. The proof is constructed by printing the image with donors of different colors.

There are advantages to analog and digital color printing techniques. Analog techniques are widely used and can print a wide number of colors. Digital techniques, by contrast, may have a more limited color palette, but allow easier storage and manipulation of the image data.

On occasion, it may be desirable to print an image using both digital and analog techniques. For example, an image may be stored digitally and therefore must be recovered by digital printing techniques. The digital printing techniques, however, may not produce the desired color quality. The person printing the image may desire that the image have, for example, a customized color instead of a standard color, such as a metallic or fluorescent color. Such customized colors may not be available with a digital printing system, but can be provided using an analog printing system.

When it is desirable to print an image using both digital and analog techniques, part of the image may be printed with digital techniques and part of the image may be printed with analog techniques. For example, one color of a digital image can be printed to a film, and the image transferred to a photosensitive medium. This color can then be transferred to the receptor with a customized color to produce the desired result. The analog portion of the image may be printed first, or the digital portion may be printed first.

Many analog and digital color printers accommodate the practice of printing a partial image to a substrate that already has a partial image. The printers accommodate techniques for aligning the substrate so that the newly printed partial image will be aligned with the previously printed partial image.

Even if the images are properly aligned, however, the two printing systems may produce images of slightly different scales. There are often minute size variations in the images generated using digital or analog techniques. When an image is printed using both an analog printing system and a digital printing system, misregistration may occur, i.e., some halftone dots printed digitally may be slightly out of place when compared to the halftone dots printed with analog techniques. The result is an aberration in the color image, a less clear color image, and an undesirable result.

The size variations may have many causes. First, the two printing systems use different equipment, and there are likely to be variations from system to system. Second, the substrate is subjected to different conditions in the systems, which may cause the substrate to shrink or stretch. For example, a color proof produced with an analog or digital printing system may undergo a thermal lamination. Because lamination may cause the size of the image to change, the size of the proof may be different from the size of the original.

### SUMMARY

In general, the invention provides scaling tools for compensating for scaling variations in printing systems. An operator wishing to print an image with two printing systems designates one of the systems as the reference printing system and the other printing system as the scalable printing system. The operator constructs a reference grid with the reference printing system and a scaling grid with the scalable printing system.

The reference grid and the scaling grid include reference lines, which are lines that will appear substantially identical on both grids. Typical reference and scaling grids include a horizontal reference line and a vertical reference line. The reference grid and the scaling grid also include one or more metric lines at distances from the reference lines. In one embodiment, the scaling grid includes a plurality of horizontal and vertical metric lines, with each metric line offset from its neighbors by an offset distance.

The operator compares the reference grid to the scaling grid. One way to compare the reference grid to the scaling grid is to overlay one grid on the other and align one of the reference lines on the reference grid with the corresponding reference line on the scaling grid. The grids may be printed on transparent substrates to facilitate the comparison, and may be overlaid on a light table or other suitable flat surface.

When the operator has aligned the reference lines of the grids, the operator observes which metric lines on the grids are most closely aligned. The scaling grid may include a scaling number that corresponds to each metric line on the scaling grid. By glancing at the scaling number that corresponds to the metric lines most closely aligned, the operator may find a scaling factor. The operator may find a horizontal scaling factor, a vertical scaling factor or both.

The operator may apply the scaling factors by setting the scale of the scalable printing system. As a result, the scalable printing system will print to the same scale as the reference printing system. The scalable printing system may be an analog system or digital system. In some embodiments, however, a digital printing system may offer greater ease and range of scalability.

In one embodiment, the invention is directed to a method comprising constructing a reference grid on one of a digital printing system and an analog printing system and constructing a scaling grid on the other of a digital printing system and an analog printing system. The method further comprises comparing the reference grid to the scaling grid and determining a scaling factor as a function of the comparison. The scaling factor may be applied to set the horizontal and/or vertical scaling of the printing system used to construct the scaling grid.

In another embodiment, the invention provides a method comprising constructing a reference grid on a reference printing system, constructing a scaling grid on a scalable printing system, comparing the reference grid to the scaling grid and determining a scaling factor as a function of the comparison. Constructing a reference grid may include constructing a reference line and a metric line on a medium, the metric line parallel to the reference line and a standard distance from the reference line. Constructing a scaling grid may include constructing a reference line on a medium, and constructing a first metric line and a second metric line on the medium parallel to the reference line. The first metric line may be closer to the reference line than the second metric line by an offset distance.

Comparison of the reference grid to the scaling grid may include laying one of the grids atop the other and aligning a reference line on the reference grid with a reference line on the scaling grid. Comparison may also include determining which of a plurality of metric lines on the scaling grid most closely aligns with a metric line on the reference grid.

In a further embodiment, the invention provides a system comprising a reference grid and a scaling grid. The reference grid comprises a first medium, a first reference line constructed on the first medium and a first metric line constructed on the first medium parallel to the first reference line and a first distance from the first reference line. The scaling grid comprises a second medium, a second reference line constructed on the second medium and a second metric line constructed on the second medium parallel to the second reference line and a second distance from the second reference line. The scaling grid may also include more than one metric line.

The invention may provide one or more advantages. For example, the invention presents simple techniques to adapt the scale of the scalable printing system to the scale of the reference printing system. The reference grid and scaling grid are relatively easy to construct and easy to compare. Furthermore, the operator can find scaling factors by comparison of the grids, without the need for fine measurements or complicated mathematical computations. Moreover, because the reference grid and the scaling grid are printed in the same manner as actual images would be printed, the grids reflect the actual relative scales of the reference and scalable printing systems.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a plan view of an exemplary reference grid.

FIG. 2 is a plan view of an exemplary scaling grid.

FIG. 3 is a plan view of the reference grid of FIG. 1 and the scaling grid of FIG. 2 superimposed and aligned.

FIG. 4 is a flow diagram illustrating an embodiment of the invention.

### DETAILED DESCRIPTION

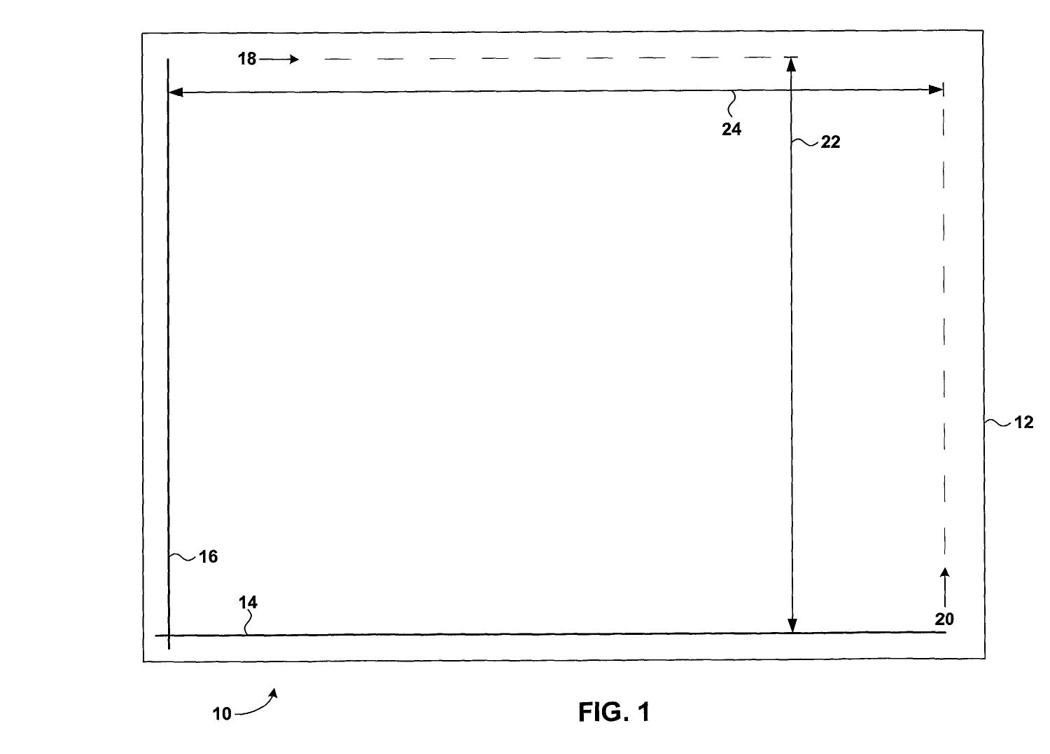

FIG. 1 is a diagram of a reference grid 10 that may be constructed in accordance with the techniques of the invention. Reference grid 10 is printed on a first medium 12 that may be of a size large enough to accommodate an image of a standard size. For purposes of illustration, standard size image dimensions of 40 inches by 30 inches (101.6 cm by 76.2 cm) will be used, but the invention is not limited to images with these exemplary dimensions. Medium 12 may be any of a number of media, but transparent film is an advantageous medium for reasons that will be discussed below.

Reference grid 10 includes a horizontal reference line 14 and a vertical reference line 16 perpendicular to horizontal reference line 14. Horizontal reference line 14 and vertical reference line 16 are close to the edges of medium 12. Horizontal reference line 14 and vertical reference line 16 may be, for example, solid one-point lines running nearly the length and width of medium 12.

Near the opposite edges of medium 12, reference grid 10 includes horizontal metric lines 18 and vertical metric lines 20. There are a plurality of horizontal metric lines 18 and a plurality of vertical metric lines 20. Each metric line may be, for example, of hairline width, 5/16 inch (0.79 cm) long, and separated from the other metric lines by 1.5 inches (3.8 cm).

Each of the horizontal metric lines 18 in reference grid 10 is a standard vertical distance 22 from horizontal reference line 14. Similarly, each of the vertical metric lines 20 in reference grid 10 is a standard horizontal distance 24 from vertical reference line 16. In an exemplary implementation of the invention, standard vertical distance 22 corresponds to the width of the standard image, or 30 inches (76.2 cm), and standard horizontal distance 24 corresponds to the length of the standard image, or 40 inches (101.6 cm).

Reference grid 10 is useful when there it is desired to print an image using two separate printing systems, such as an analog printing system and a digital printing system. In a typical application, one of the printing systems would be designated the reference printing system, and the other would be designated the scalable printing system. In many cases, it is irrelevant which of the two printing systems is designated as the reference system and which is designated the scalable printing system. In some embodiments, however, a digital printing system may offer greater ease and range of scalability than an analog printing system. The reference printing system is used to construct reference grid 10.

When the reference system is an analog system, reference grid 10 may be constructed using digital techniques. In particular, reference grid 10 may be laid out using page setup software such as QuarkXPress, commercially available from Quark, Inc, of Denver, Colo. The page setup document is digitally processed to produce either a positive or negative image on a transparent film.

When the reference system is a digital system, reference grid 10 may be constructed using digital techniques. Reference grid 10 is laid out and printed as a positive, and is printed on or transferred to a medium such as transparent film. The medium is processed through the proofmaking process, so that reference grid 10 takes into account any size changes that may occur in the processing. For example, when the proofmaking process includes lamination that may result in size changes, reference grid 10 should undergo lamination to reflect the changes.

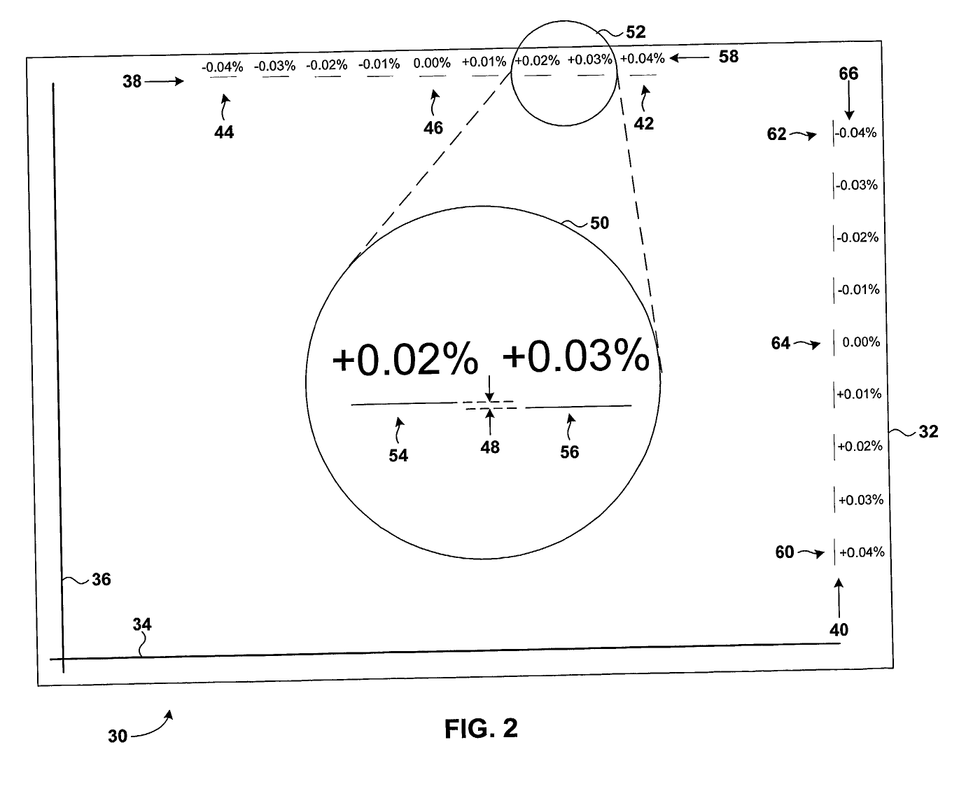

FIG. 2 is a diagram of a scaling grid 30 that may be constructed in accordance with the techniques of the invention. Scaling grid 30 is printed on a second medium 32 of the same size as first medium 12. Like medium 12, medium 32 may be any of a number of media, but transparent film is an advantageous medium. Scaling grid 30 is printed with the scalable printing system.

Like reference grid 10, scaling grid 30 includes a horizontal reference line 34 and a vertical reference line 36 perpendicular to horizontal reference line 34, close to the edges of medium 32. Horizontal reference line 34 and vertical reference line 36 ordinarily have the same length and thickness as horizontal reference line 14 and vertical reference line 16 of reference grid 10.

Like reference grid 10, scaling grid 30 includes a plurality of horizontal metric lines 38 and vertical metric lines 40, approximately the same length and thickness as horizontal metric lines 18 and vertical metric lines 20 of reference grid 10. Unlike horizontal metric lines 18 and vertical metric lines 20 of reference grid 10, however, horizontal metric lines 38 and vertical metric lines 40 of scaling grid 30 are different distances from horizontal reference line 34 and vertical reference line 36.

Of all horizontal metric lines 38, horizontal metric line 42 is the closest to horizontal reference line 34, and horizontal metric line 44 is the farthest from horizontal reference line 34. Horizontal metric line 46 is constructed such that, if reference grid 10 and scaling grid 30 were constructed to exactly the same vertical scale, horizontal metric line 46 would be located standard vertical distance 22 from horizontal reference line 34. Due to size variations in printing systems, however, horizontal metric line 46 may be closer to or further from horizontal reference line 34 than standard vertical distance 22.

Horizontal metric lines 38 are constructed parallel to horizontal reference line 34, but the individual horizontal metric lines are offset from each other by a vertical offset distance. An example of a vertical offset distance 48 is shown in area 50, which is area 52 enlarged for clarity. Vertical offset distance 48 represents the offset between adjacent metric lines 54 and 56. Each horizontal metric line is similarly offset from its neighbor by vertical offset distance 48.

In one embodiment of the invention, vertical offset distance 48 is a function of the standard width of the image. If, for example, the standard width of the image is 30 inches (76.2 cm), then vertical offset distance 48 may be 0.003 inches (76.2 micrometers), or 0.01% of the standard width. Horizontal metric lines 38 may be accompanied by vertical scaling numbers 58, which make scaling grid 30 more user-friendly. The use of vertical scaling numbers 58 will be described in more detail below.

Similarly, vertical metric lines 40 are different distances from vertical reference line 36. Vertical metric line 60 is the closest to vertical reference line 36, and vertical metric line 62 is the farthest from vertical reference line 36. Vertical metric line 64 is constructed such that, if reference grid 10 and scaling grid 30 were constructed to exactly the same horizontal scale, vertical metric line 64 would be standard horizontal distance 24 from vertical reference line 36. Due to size variations in printing systems, however, vertical metric line 64 may be closer to or further from vertical reference line 36 than standard horizontal distance 24.

Vertical metric lines 40 are constructed parallel to vertical reference line 36, but the individual vertical metric lines are offset from their neighbors by a horizontal offset distance. The horizontal offset distance is similar to vertical offset distance 48 shown in FIG. 2.

The horizontal offset distance need not be the same as the vertical offset distance. In one embodiment of the invention, the horizontal offset distance is a function of the standard length of the image. If, for example, the standard length of the image is 40 inches (101.6 cm), then the horizontal offset distance may be 0.004 inches (101.6 micrometers). Just as vertical offset distance 48 is or 0.01% of the standard width, the horizontal offset distance is 0.01% of the standard height. Vertical metric lines 40 may be accompanied by vertical scaling numbers 66, which will be described in more detail below.

Scaling grid 30 may be constructed on the scalable printing system using analog and/or digital techniques, as described above in connection with reference grid 10.

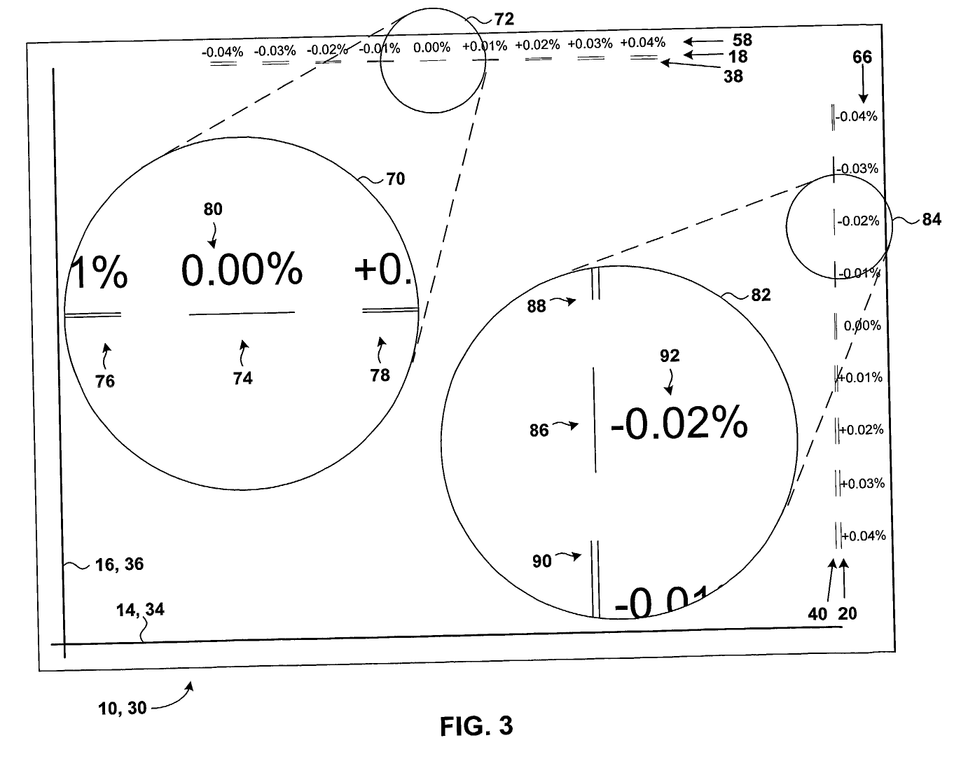

FIG. 3 illustrates a typical application of reference grid 10 and scaling grid 30. Reference grid 10 has been constructed on the reference printing system and scaling grid 30 has been constructed on the scalable printing system. At least one of the reference grid 10 and scaling grid 30 is printed on a transparent medium. Reference grid 10 and scaling grid 30 are overlaid. Horizontal reference lines 14 and 34 have been brought into alignment, as have vertical reference lines 16 and 36. In practice, horizontal reference lines 14 and 34 and vertical reference lines 16 and 36 need not be aligned at the same time.

An operator may overlay reference grid 10 and scaling grid 30 on a flat surface such as a light table. The operator smoothes grids 10 and 30, and aligns either horizontal reference lines 14 and 34, or aligns vertical reference lines 16 and 36, or aligns both sets of reference lines. The alignment may be checked by using a precision instrument such as a loupe. When reference grid 10 and scaling grid 30 are aligned, the operator may affix grids 10, 30 to one another, such as with an adhesive, so that grids 10, 30 will not accidentally shift out of alignment.

After grids 10, 30 are aligned, the operator examines the metric lines corresponding to the aligned reference lines. For example, if horizontal reference lines 14 and 34 are aligned, then horizontal metric lines 18 and 38 are examined. Because horizontal metric lines 38 on scaling grid 30 are offset from their neighbors by a horizontal offset, not all horizontal metric lines 18 and 38 can be aligned. In a typical application, only one of horizontal metric lines 38 on scaling grid 30 will align with, or come closest to alignment with, one of horizontal metric lines 18 on reference grid 10.

In FIG. 3, the closest alignment of horizontal metric lines occurs in area 70, which is area 72 enlarged for clarity. Metric lines 74 align, or align most closely. Neighboring metric lines 76 and 78 align less closely. The site of closest alignment corresponds to a vertical scaling number 80 of 0.00%. From this, the operator determines that the vertical scaling factor is 0.00%. In other words, the vertical scales on both reference grid 10 and scaling grid 30 are nearly identical, and no vertical adjustment of the scalable printing system will be required.

When vertical reference lines 16 and 36 are aligned, the operator examines vertical horizontal metric lines 20 and 40. Because vertical metric lines 40 on scaling grid 30 are offset from their neighbors by a vertical offset, not all vertical metric lines 20 and 40 can be aligned. As with horizontal metric lines, typically only one of vertical metric lines 40 on scaling grid 30 will align with, or come closest to alignment with, one of vertical metric lines 20 on reference grid 10.

In FIG. 3, the closest alignment of vertical metric lines occurs in area 82, which is area 84 enlarged for clarity. Metric lines 86 align, or align most closely. Neighboring metric lines 88 and 90 align less closely. The site of closest alignment corresponds to a vertical scaling number 92 of −0.02%. From this, the operator determines that the vertical scaling factor is −0.02%. In other words, in the horizontal direction, the scaling grid has shrunk by two one hundredths of a percent. The operator may compensate for the shrinkage in the horizontal direction by making a horizontal adjustment to the scalable printing system of two one hundredths of a percent.

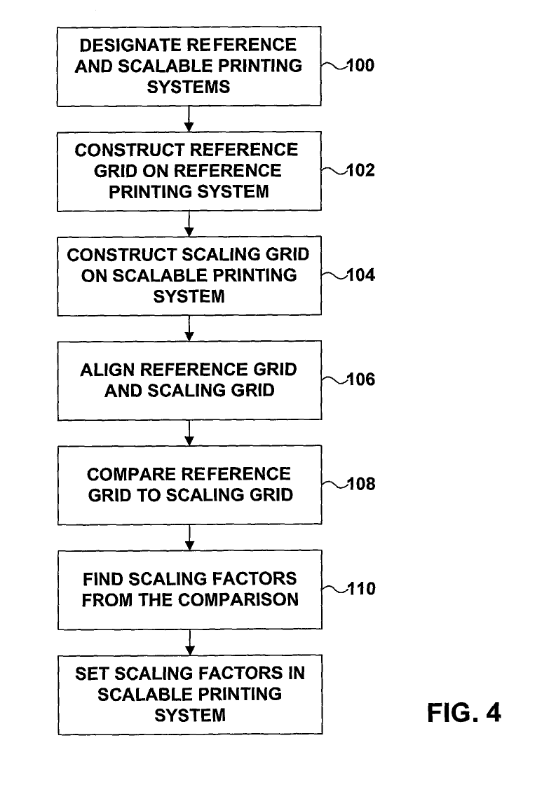

FIG. 4 is a flow diagram that illustrates an embodiment of the invention. An operator designates a reference printing system and a scalable printing system (100). The reference printing system is a printing system that will not be adjusted, and the scalable printing system is a printing system that will be adjusted to the scale of the reference printing system. Many analog and digital printing systems, such as Matchprint Analog and Digital Proofing Systems commercially available from Imation Corp. of Oakdale, Minn., are capable of adjusting horizontal and vertical scaling. When both printing systems are scalable, then either system may be selected as the reference printing system or the scalable printing system. The operator may designate, for example, that an analog printing system will be the reference printing system and a digital printing system will be the scalable printing system.

The operator constructs a reference grid on the reference printing system (102), using the techniques described above. The operator also constructs a scaling grid on the scalable printing system (104), using the techniques described above. When the reference grid and the scaling grid are printed, the operator may overlay the grids on a light table or other flat surface. The operator smoothes the grids and aligns either the horizontal reference lines or the vertical reference lines or both sets of reference lines (106).

It may be more convenient for the operator to align the horizontal reference lines and the vertical reference lines independently, because the alignment should be as precise as possible, and it may be more difficult to align in two dimensions than in one dimension. The alignment may be checked with a precision instrument such as a loupe. When the reference grid and scaling grid are aligned, the operator may affix the grids to one another so that the grids will not accidentally shift out of alignment.

The operator compares the reference grid and the scaling grid to one another (108) and finds the scaling factors from the comparison (110). FIG. 3 illustrates techniques for comparison. The operator determines which metric line on the scaling grid most closely aligns with a metric line on the reference grid. The operator may employ an instrument such as a loupe to determine which metric line on the scaling grid most closely aligns with a metric line on the reference grid. The operator may find the scaling factor by observing the scaling number that corresponds to the metric line on the scaling grid that most closely aligns with a metric line on the reference grid. The operator finds a horizontal scaling factor and a vertical scaling factor.

The operator then applies the horizontal and vertical scaling factors by setting the scale of the scalable printing system. As shown in FIGS. 2 and 3, scaling numbers 58, 66 are given as percentages. Many scalable printing systems use percentages, rather than inches or centimeters, as scaling units. Scaling numbers 58, 66 therefore give the operator at a glance the information needed to set the horizontal and vertical scaling factors on the scalable printing system.

Printing on the reference and scaling systems may then be done in the conventional manner. A proof may be printed, for example, on the reference system first, followed by a second printing on the scalable printing system. Because the operator has set the horizontal and/or vertical scaling on the scalable printing system, the scale variations generated by the differences in the systems is reduced. In particular, the halftone dots printed on one system will be in place when compared to the halftone dots printed with the other system. In this way, the color image is in better registration.

The invention offers several advantages. The reference grid and scaling grid are easy to construct and easy to compare. The comparison need not involve any measurements or complicated mathematical computations by the operator. Rather, the operator can refer to the scaling number proximal to the metric lines that are most closely aligned, and can find the scaling factor at a glance. Furthermore, the reference and scaling grids reflect the actual relative scales of the reference and scalable printing systems.

Various embodiments of the invention have been described. Nevertheless, various modifications may be made without departing from the scope of the invention. For example, FIG. 2 shows scaling numbers 58, 66 as a part of scaling grid 30, but the scaling numbers may be a part of reference grid 10. Furthermore, scaling numbers 58, 66 are shown as percentages, but may alternatively be shown as decimals or in units of length such as inches or millimeters. Moreover, metric lines may be offset from one another in reference grid 10 and aligned with one another in scaling grid 30. More or fewer metric lines may be used than are shown in FIGS. 1-3.

Furthermore, the signs of the scaling numbers 58, 66 on scaling grid 30 may be reversed. As described above, the plus or minus signs inform the operator about the amount of expansion or shrinkage of scaling grid 30, relative to reference grid 10. The sign convention may instead inform the operator as to the amount of adjustment recommended for to the scalable printing system. For example, scaling number 92 in FIG. 3 may read +0.02% instead of −0.02%, informing the operator that the operator may compensate for the size difference in the horizontal direction by making a positive horizontal adjustment to the scalable printing system of two one hundredths of a percent. The invention encompasses both sign conventions.

Reference grid 10 and scaling grid 30 need not be precisely in the format shown in FIGS. 1 and 2. Reference grid 10 and scaling grid 30 may, for example, be marked with squares formed of thin lines crossing at right angles and at equal intervals, like quadrille paper. On reference grid 10, metric lines 18, 20 may be drawn as single, rather than broken, lines. The reference grid and scaling grid may take the form of other images that, when compared to one another by the operator, make it possible for the operator to determine a scaling factor as a function of the comparison.

In addition, the application of these techniques is not limited to digital and analog printing systems. The techniques may be applied to any two printing systems that cooperate to print an image on a medium. The techniques may also be adapted to more than two printing systems that cooperate to produce an image. One printing system may be designated as the reference printing system, and the other printing systems may be designated as the scalable printing systems. Following comparison of the scaling grids to the reference grid, the scalable printing systems may be set to print to the same scale as the reference printing system. These and other embodiments are within the scope of the following claims.

1. A method comprising:
constructing a reference grid on one of a digital printing system and an analog printing system;
constructing a scaling grid on the other of the digital printing system and the analog printing system;
comparing the reference grid to the scaling grid; and
determining a scaling factor as a function of the comparison.

2. The method of claim 1, further comprising applying the scaling factor to the printing system on which the scaling grid was constructed.

3. The method of claim 2, further comprising printing part of an image on the printing system on which the reference grid was constructed and printing another part of the image on the printing system on which the scaling grid was constructed.

4. The method of claim 1,
wherein constructing the reference grid comprises printing the reference grid on a first transparent medium;
wherein constructing the scaling grid comprises printing the reference grid on a second transparent medium; and
wherein comparing the reference grid to the scaling grid comprises laying one of the reference grid and the scaling grid atop the other of the reference grid and the scaling grid.

5. The method of claim 1, wherein determining a scaling factor comprises determining a horizontal scaling factor and determining a vertical scaling factor.

6. A method comprising:
constructing a reference grid on a reference printing system;
constructing a scaling grid on a scalable printing system;
comparing the reference grid to the scaling grid; and
determining a scaling factor as a function of the comparison.

7. The method of claim 6, further comprising setting the scaling on the scalable printing system as a function of the scaling factor.

8. The method of claim 7, further comprising printing part of an image on the reference printing system and printing another part of the image on the scalable printing system.

9. The method of claim 6, wherein constructing the reference grid comprises:
constructing a reference line on a medium; and
constructing a metric line on the medium parallel to the reference line and a standard distance from the reference line.

10. The method of claim 6, wherein constructing the scaling grid comprises:
constructing a reference line on a medium; and
constructing a first metric line and a second metric line on the medium parallel to the reference line, the first metric line closer to the reference line than the second metric line by an offset distance.

11. The method of claim 6, wherein comparing the reference grid to the scaling grid comprises:
laying one of the reference grid and the scaling grid atop the other of the reference grid and the scaling grid;
aligning a reference line on the reference grid with a reference line on the scaling grid; and
determining which of a plurality of metric lines on the scaling grid most closely aligns with a metric line on the reference grid.

12. The method of claim 11, wherein determining a scaling factor as a function of the comparison comprises observing a scaling number that corresponds to the metric line on the scaling grid that most closely aligns with the metric line on the reference grid.

13. The method of claim 6, wherein the scaling factor is a horizontal scaling factor, the method further comprising determining a vertical scaling factor as a function of the comparison.

14. A system comprising:
a reference grid comprising:
a first medium;
a first reference line constructed on the first medium; and
a first metric line constructed on the first medium parallel to the first reference line and a first distance from the first reference line,
a scaling grid comprising:
a second medium;
a second reference line constructed on the second medium;
a second metric line constructed on the second medium parallel to the second reference line and a second distance from the second reference line.

15. The system of claim 14, further comprising a reference printing system that constructs the reference grid and a scalable printing system that constructs the scaling grid.

16. The system of claim 15, wherein the reference printing system is one of a digital printing system and an analog printing system and wherein the scalable printing system is the other of the digital printing system and the analog printing system.

17. The system of claim 14,
wherein the reference grid is constructed with one of a digital printing system and an analog printing system, and
wherein the scaling grid is constructed with the other of the digital printing system and the analog printing system.

18. The system of claim 14, the scaling grid further comprising:
a third metric line constructed on the second medium parallel to the second reference line and a third distance from the second reference line;
a first scaling number constructed on the second medium proximal to the second metric line; and
a second scaling number constructed on the second medium proximal to the third metric line.

19. The system of claim 14, the reference grid further comprising:
a third reference line constructed on the first medium perpendicular to the first reference line; and
a third metric line constructed on the first medium parallel to the third reference line and a third distance from the third reference line.

20. The system of claim 14, the scaling grid further comprising:
a third reference line constructed on the second medium perpendicular to the second reference line; and
a third metric line constructed on the second medium parallel to the third reference line and a third distance from the third reference line.

21. The system of claim 14, wherein at least one of the first medium and the second medium is transparent.

22. A method comprising:
determining a scaling factor as a function of a comparison of a reference image printed on a reference printing system and a scaling image printed on a scalable printing system;
applying the scaling factor to the scalable printing system;
printing part of an image on the reference printing system; and
printing another part of the image on the scalable printing system.

23. The method of claim 22, wherein the reference image comprises a reference line on a medium and a metric line on the medium parallel to the reference line and a standard distance from the reference line.

24. The method of claim 22, wherein the scaling image comprises a reference line on a medium, and a first metric line and a second metric line on the medium parallel to the reference line, the first metric line closer to the reference line than the second metric line by an offset distance.

25. The method of claim 22, wherein comparison of the reference image and the scaling image comprises:
laying one of the reference image and the scaling image atop the other of the reference image and the scaling image; and
aligning a reference line on the reference image with a reference line on the scaling image.

26. The method of claim 22, wherein scaling factor is a horizontal scaling factor, the method further comprising determining a vertical scaling factor as a function of a second comparison of the reference image and the scaling image.
